(19) United States
(12) Patent Application Publication
(10) Pub. No.: US 2009/0210871 A1
(43) Pub. Date: Aug. 20, 2009

(54) SYSTEM AND METHOD FOR SOFTWARE APPLICATION MIGRATION

(76) Inventor: Zak Dechovich, Kfar Saba (IL)

Correspondence Address: Professional Patent Solutions, P.O. BOX 654, HERZELIYA PITUACH, 46105, IL

(21) Appl. No.: 12/033,914

(22) Filed: Feb. 20, 2008

(51) Int. Cl. G06F 9/445; G06F 17/30; G06F 7/06

(52) U.S. Cl. 717/178; 707/100; 707/3; 707/E17.014

(57) ABSTRACT

Disclose is a system and method for one or more software applications from a source computing platform to a destination computing platform, by identifying installed software components. According to some embodiments of the present invention, a software application may be migrated by generating a list of its components, and downloading components according to the generated list.

### FIELD OF THE INVENTION

The present invention relates generally to the field of computing. More specifically, the present invention relates to a method and system for software application migration.

### BACKGROUND

There is no simple way to migrate a working environment from one computer to another. When switching to a new computer, the user has to copy all data from the old computer to the new one, and reinstall all applications. This is a very complicated task and may require assistance from a costly technician. Migrating is a time consuming, complicated and expensive task.

There are no simple migration techniques because applications are merged too deeply in the hosting operating system. There are numerous places where application components can be installed, whether they are files, registry keys and values, and settings for that local machine. There is no unified tracking of all objects or components of an application. For example, an application could be installed in a specific directory and all of its components would relay on that directory. Transferring application as-is from one computer to another would fail, even when assuming one has found all the embedded components.

It would be useful, therefore to have a method for migrating computer software components between computers or operating systems.

### SUMMARY OF THE INVENTION

The present invention is a system and method for one or more software applications from a source computing platform to a destination computing platform, by identifying installed software components. According to some embodiments of the present invention, a software application may be migrated by generating a list of its components, and downloading components according to the generated list.

According to some embodiments of the present invention, a software migration system server may store sets of related software application image blocks in a software image repository. According to some embodiments of the present invention, the software image repository may be located on a data storage device associated with the migration server. According to alternative embodiments of the present invention, the software image repository may be distributed across one more servers and/or end-users' computers functionally associated with the migration server. According to other embodiments of the present invention, the repository may be located on one or more mass storage devices (e.g. removable HD, USB storage, etc.) functionally associated with the client.

According to some embodiments of the present invention, reference image blocks associated a given application may be generated by parsing the application's installation files. According to alternative embodiments of the present invention, a reference image block may be generated by monitoring an installation process of the given application. According to other embodiments of the present invention, an image block may be generated by collecting data from a number of client computers, and identifying the similarities and differences between them. Any method or technology for generating reference image blocks known today or to be devised in the future may be applicable to the present invention.

According to some embodiments of the present invention, an application image block may be defined as: (1) a partial or full image of a file associated with the application, (2) an image of one or more files associated with the application, (3) registry keys and values associated with the application, and (4) entries in configuration files and/or any other data associated (i.e. operating system objects) with the application. It should be clear to one of ordinary skill in the art that an Image block of a given software application may be defined and/or composed of any data which constitutes or is otherwise associated with the software application. According to further embodiments of the present invention, an image block may be normalized, i.e. with installation-specific information (e.g. installation path, environment variables, user names, and other such settings) replaced with generic variables. According to further embodiments of the present invention, relative configuration between a normalized reference image block and the installed application image block may be taken into account and the corresponding object structures and may be mapped from the reference object structure to the installed object structure. According to alternative embodiments of the present invention, an image block may be stored as absolute data, containing a true replicate image of an installed component.

According to some embodiments of the present invention, a migration server and a source client computer may communicate via a distributed data network (e.g. Internet). Image block characterization data relating to applications installed on the source client may be exchanged between the client and the migration server. According to some embodiments of the present invention, an application scanning module on a source client may identify installed applications or components associated with installed applications, and may transmit through a communication module the data associated with identified applications. According to further embodiments of the present invention, the application scanning module may identify installed applications and application components based on application image blocks. According to further embodiments of the present invention, the application scanning module may identify installed applications and application components based on operating system data (e.g. Windows registry).

According to some embodiments of the present invention, the application scanning module may generate only a list of identified applications, a list of identified application image blocks, or any other data which would allow the migration system to determine which application image blocks are installed on the client.

According to some embodiments of the present invention, the application scanning module may also be adapted to perform customized or application-specific checks to locate user data on the client, such as documents files, or specific components (e.g. modified components, client-specific data, or configuration settings,) or any other data that may be associated with the application, and may create a list of user data files and specific components to be migrated.

According to some embodiments of the present invention, the scanning module may save the generated list on a storage device associated with the client. According to alternative embodiments of the present invention, the application scanning module may transmit the generated list to a migration server.

According to some embodiments of the present invention, a migration server and a destination client computer may communicate via a distributed data network (e.g. Internet). Image block characterization data relating to applications to be installed on the destination client may be exchanged between the client and the migration server. According to some embodiments of the present invention, an application migration module on a destination client may receive information related to applications or components associated with applications. According to some embodiments of the present invention, the application migration server may transmit through a communication module the application image blocks associated with applications to be installed on the client.

According to some embodiments of the present invention, the migration module may read the image block list from a storage device associated with the client. According to some embodiments of the present invention, the migration module may also restore client-specific data associated with the migrated applications, such as document files, configuration settings, and/or any other data that may be required by the application or the user.

According to further embodiments of the present invention, if a reference image block received from the migration server is normalized, the application migration module on the client computer may replace the normalized image's generic variables with values specific to the client computer. The migration module may take into account relative configuration deltas between a normalized image block and the current configuration and/or settings and may map corresponding object structures from the reference object structure to the installed object structure.

According to alternative embodiments of the present invention, if an image block sent by the server was absolute, the migration module may identify which settings are general and which are installation-specific, and may modify them accordingly.

Various methods, techniques and technologies for generating, storing and using software component image blocks to achieve software system remediation are taught in PCT application PCT/IL 2007/000677, which PCT application is co-owned by the assignee of the present application. PCT application PCT/IL 2007/000677 is hereby incorporated by reference in its entirety.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram illustrating the main components of an exemplary software migration system in accordance with some embodiments of the present invention;

FIG. 2 is a block diagram illustrating the functional building blocks of a software migration server in accordance with some embodiments of the present invention;

FIG. 3A is a flowchart illustrating an exemplary method by which applications are migrated from a source client to a destination client by a software migration server from the viewpoint of a migration server in accordance with some embodiments of the present invention;

FIG. 3B is a flowchart illustrating an exemplary method by which applications are migrated from a source client to a destination client by a software migration server from the viewpoint of a migration server in accordance with some embodiments of the present invention;

FIG. 4A is a block diagram illustrating the functional building blocks of a software migration system source client in accordance with some embodiments of the present invention;

FIG. 4B is a block diagram illustrating the functional building blocks of a software migration system target client in accordance with some embodiments of the present invention;

FIG. 5A is a flowchart illustrating an exemplary method by which applications are migrated from a source client to a destination client by a software migration server from the viewpoint of a source client in accordance with some embodiments of the present invention; and

FIG. 5B is a flowchart illustrating an exemplary method by which applications are migrated from a source client to a target client by a software migration server from the viewpoint of a target client in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

The present invention is a system and method for one or more software applications from a source computing platform to a destination computing platform, by identifying installed software components. According to some embodiments of the present invention, a software application may be migrated by generating a list of its components, and downloading components according to the generated list.

According to some embodiments of the present invention, a software migration system server may store sets of related software application image blocks in a software image repository. According to some embodiments of the present invention, the software image repository may be located on a data storage device associated with the migration server. According to alternative embodiments of the present invention, the software image repository may be distributed across one more servers and/or end-users' computers functionally associated with the migration server. According to other embodiments of the present invention, the repository may be located on one or more mass storage devices (e.g. removable HD, USB storage, etc.) functionally associated with the client.

According to some embodiments of the present invention, reference image blocks associated a given application may be generated by parsing the application's installation files. According to alternative embodiments of the present invention, a reference image block may be generated by monitoring an installation process of the given application. According to other embodiments of the present invention, an image block may be generated by collecting data from a number of client computers, and identifying the similarities and differences between them. Any method or technology for generating reference image blocks known today or to be devised in the future may be applicable to the present invention.

According to some embodiments of the present invention, an application image block may be defined as: (1) a partial or full image of a file associated with the application, (2) an image of one or more files associated with the application, (3) registry keys and values associated with the application, and (4) entries in configuration files and/or any other data associated (i.e. operating system objects) with the application. It should be clear to one of ordinary skill in the art that an Image block of a given software application may be defined and/or composed of any data which constitutes or is otherwise associated with the software application. According to further embodiments of the present invention, an image block may be normalized, i.e. with installation-specific information (e.g. installation path, environment variables, user names, and other such settings) replaced with generic variables. According to further embodiments of the present invention, relative configuration between a normalized reference image block and the installed application image block may be taken into account and the corresponding object structures and may be mapped from the reference object structure to the installed object structure. According to alternative embodiments of the present invention, an image block may be stored as absolute data, containing a true replicate image of an installed component.

According to some embodiments of the present invention, a migration server and a source client computer may communicate via a distributed data network (e.g. Internet). Image block characterization data relating to applications installed on the source client may be exchanged between the client and the migration server. According to some embodiments of the present invention, an application scanning module on a source client may identify installed applications or components associated with installed applications, and may transmit through a communication module the data associated with identified applications. According to further embodiments of the present invention, the application scanning module may identify installed applications and application components based on application image blocks. According to further embodiments of the present invention, the application scanning module may identify installed applications and application components based on operating system data (e.g. Windows registry).

According to some embodiments of the present invention, the application scanning module may generate only a list of identified applications, a list of identified application image blocks, or any other data which would allow the migration system to determine which application image blocks are installed on the client.

According to some embodiments of the present invention, the application scanning module may also be adapted to perform customized or application-specific checks to locate user data on the client, such as documents files, or specific components (e.g. modified components, client-specific data, or configuration settings,) or any other data that may be associated with the application, and may create a list of user data files and specific components to be migrated.

According to some embodiments of the present invention, the scanning module may save the generated list on a storage device associated with the client. According to alternative embodiments of the present invention, the application scanning module may transmit the generated list to a migration server.

According to some embodiments of the present invention, a migration server and a destination client computer may communicate via a distributed data network (e.g. Internet). Image block characterization data relating to applications to be installed on the destination client may be exchanged between the client and the migration server. According to some embodiments of the present invention, an application migration module on a destination client may receive information related to applications or components associated with applications. According to some embodiments of the present invention, the application migration server may transmit through a communication module the application image blocks associated with applications to be installed on the client.

According to some embodiments of the present invention, the migration module may read the image block list from a storage device associated with the client. According to some embodiments of the present invention, the migration module may also restore client-specific data associated with the migrated applications, such as document files, configuration settings, and/or any other data that may be required by the application or the user.

According to further embodiments of the present invention, if a reference image block received from the migration server is normalized, the application migration module on the client computer may replace the normalized image's generic variables with values specific to the client computer. The migration module may take into account relative configuration deltas between a normalized image block and the current configuration and/or settings and may map corresponding object structures from the reference object structure to the installed object structure.

According to alternative embodiments of the present invention, if an image block sent by the server was absolute, the migration module may identify which settings are general and which are installation-specific, and may modify them accordingly.

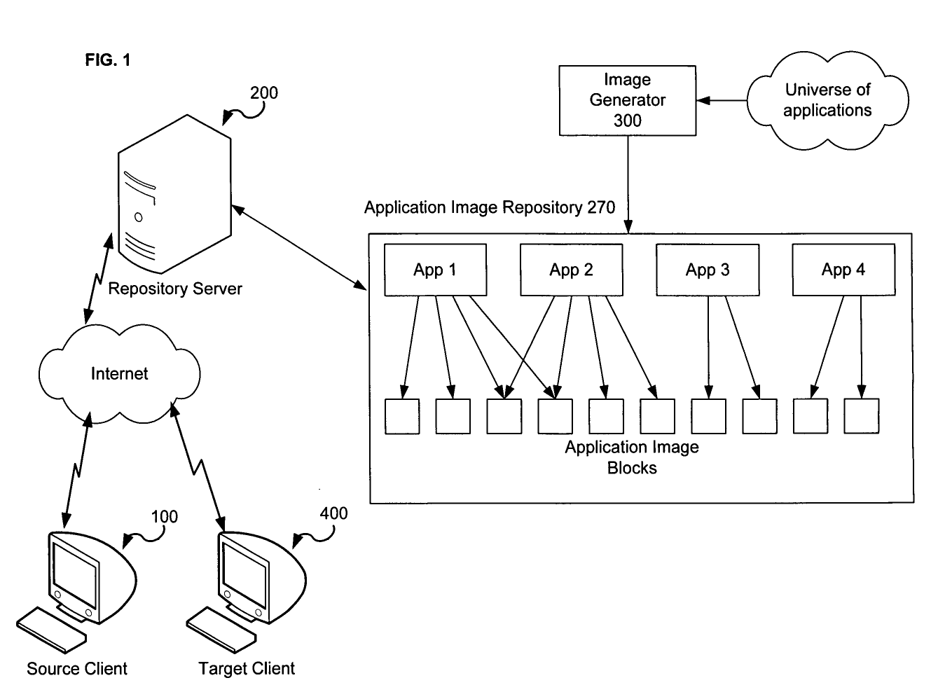

Reference is now made to FIG. 1, which is a block diagram illustrating the main components of an exemplary software remediation system in accordance with some embodiments of the present invention. According to some embodiments of the present invention, a remote server 200 may be functionally associated with an application image repository 270, which is created and maintained by the image generator 300. A source client computer 100 may connect over a network to a server, and exchange information related to the application components installed on it, and a target client computer 400 may connect over a network to a server and exchange information related to the application components to be installed on it.

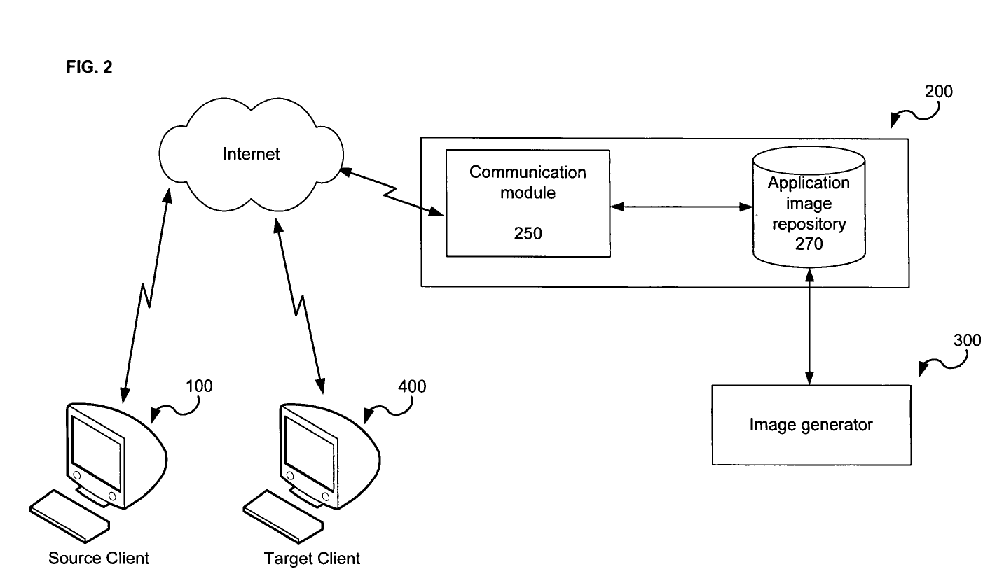

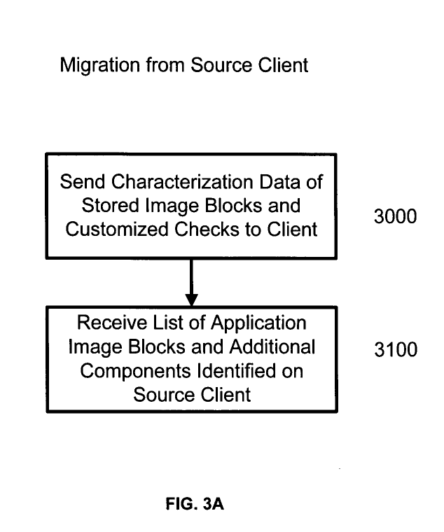

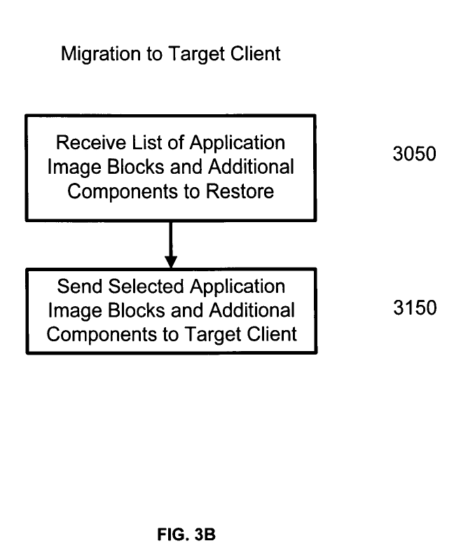

Reference is now made to FIG. 3A, which is a flowchart illustrating an exemplary method by which a software migration server saves the configuration of a source client computer from the viewpoint of a migration server in accordance with some embodiments of the present invention, and to FIG. 2, which is a block diagram illustrating the functional building blocks of a software migration server in accordance with some embodiments of the present invention. According to some embodiments of the present invention, a source client computer 100 connects to the server 200 via the communication module 250, and receives characterization data for application image blocks stored in the repository 270 and customized checks to perform (step 3000). The source client 100 then sends the server characterization data for application image blocks it has identified, and also for specific and additional components, e.g. modified components or client-specific data (step 3100) to be saved for the restore process.

Reference is now made to FIG. 3B, which is a flowchart illustrating an exemplary method by which a software migration server restores a saved configuration of a source client computer to a target client from the viewpoint of a migration server in accordance with some embodiments of the present invention, and to FIG. 2, which is a block diagram illustrating the functional building blocks of a software migration server in accordance with some embodiments of the present invention. According to some embodiments of the present invention, a migration server 200 accepts a connection from a target client computer 400 via the communication module 250, and receives a list of image blocks to restore (step 3050). The server 200 then sends the target client 400 the requested application image blocks and additional components, e.g. modified components or client-specific data to restore (step 3150).

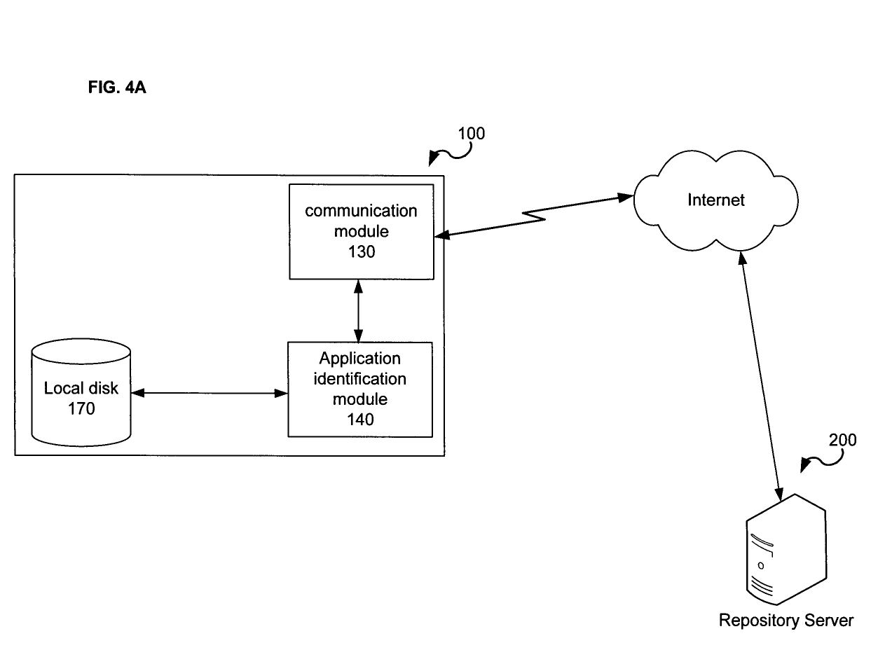

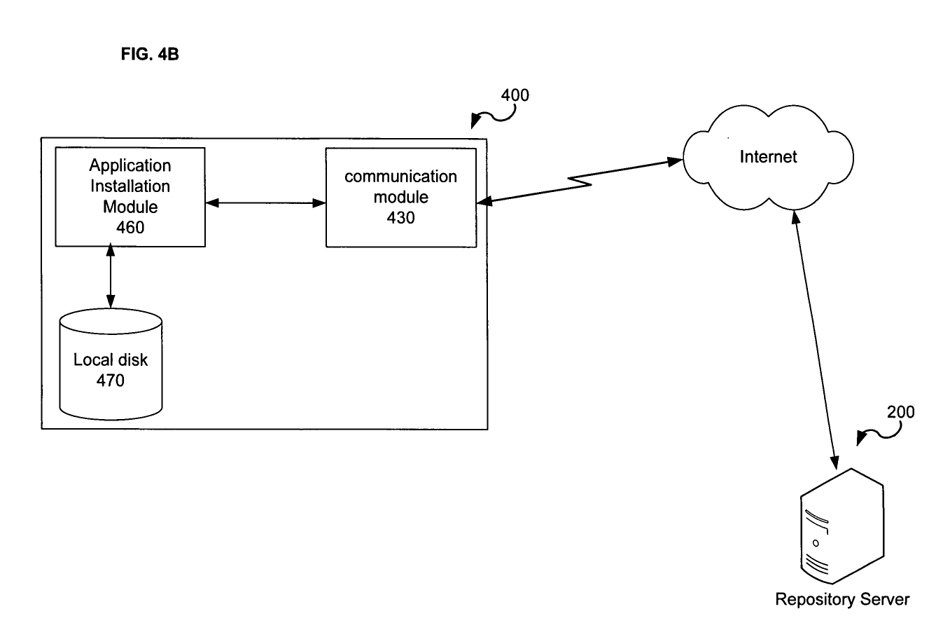

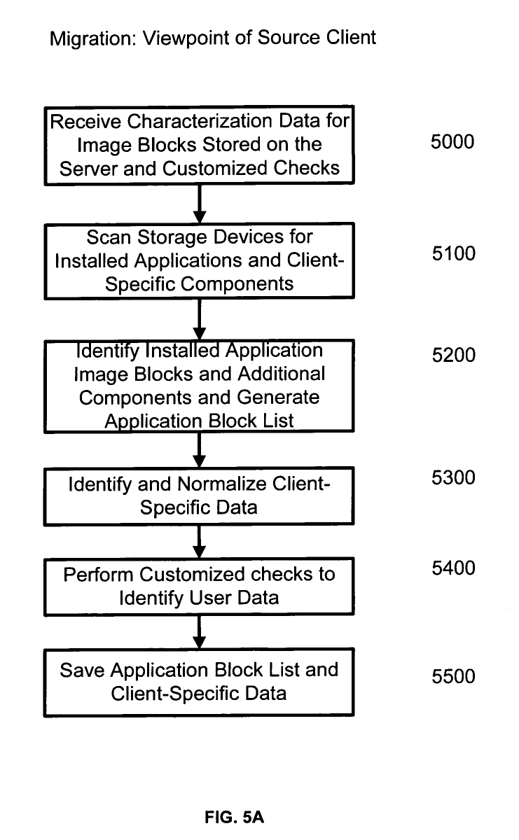

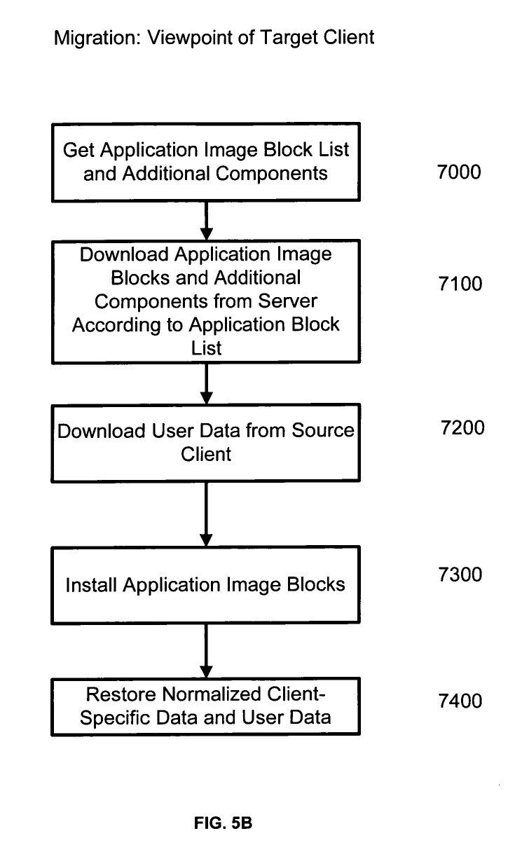

Reference is now made to FIG. 4A, which is a block diagram illustrating the functional building blocks of a software migration system source client in accordance with some embodiments of the present invention, and to FIG. 5A, which is a flowchart illustrating an exemplary method by which installed applications are migrated between computing platforms from the viewpoint of a source client computer in accordance with some embodiments of the present invention. According to some embodiments of the present invention, a source client computer 100 connects to a server 200 via the communication module 130 and receives characterization data for application image blocks stored in the repository 270 and customized checks to perform (step 5000). The application identification module 140 then scans the local storage 170 for installed applications (step 5100), and generates a list of application image blocks and additional components (e.g. modified components) identified (step 5200). The application identification module 140 then identifies client-specific data (e.g. data files, application settings) and normalizes it (step 5300). The application scanning module 140 then performs customized checks to locate user data to be migrated (step 5400). The generated lists are then saved, either on a local storage device, a removable storage device, or on the server (step 5500).

Reference is now made to FIG. 4B, which is a block diagram illustrating the functional building blocks of a software migration system target client in accordance with some embodiments of the present invention, and to FIG. 5B, which is a flowchart illustrating an exemplary method by which installed applications are migrated between computing platforms from the viewpoint of a target client computer in accordance with some embodiments of the present invention. According to some embodiments of the present invention, a target client computer 400 connects to a server 200 via the communication module 430 and receives a list of application image blocks and additional components (e.g. modified components, client-specific data or user data) to download from the repository 270 (step 7000). The application installation module 460 then downloads the application image blocks and additional components from the server 200 (step 7100). The application installation module then downloads user data from the source client (step 7200). The application installation module 460 then installs the application image blocks (step 7300), and restores the normalized client-specific data and user data (step 7400).

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A system for migrating one or more application between computing platforms comprising:
a scanning module adapted to identify application image blocks on a source client computing platform; and
a migration module adapted to install application image blocks on a target client computing platform, wherein said application image blocks are correlated with identified image blocks on the source client.

2. The system according to claim 1, further comprising an application image block repository adapted to store application image blocks on a storage device associated with said first client computing platform.

3. The system according to claim 1, wherein said scanning module is further adapted to perform customized checks for specific components.

4. The system according to claim 3, wherein said scanning module is further adapted to perform customized checks for user data.

5. The system according to claim 1, wherein said scanning module is further adapted to generate a list of application image blocks on a storage device associated with said first client computing platform.

6. The system according to claim 2, wherein said migration module is further adapted to receive application image blocks from said application image block repository.

7. The system according to claim 1, further comprising a communication module adapted to receive application image blocks from a server.

8. A system for migrating one or more applications between computing platforms comprising:
a scanning module adapted to identify application image blocks on a client computing platform and generate a list of identified blocks; and
a communication module adapted to send the generated list to a server.

9. The system according to claim 8, wherein said scanning module is further adapted to perform customized checks for specific components.

10. The system according to claim 9, wherein said scanning module is further adapted to perform customized checks for user data.

11. A system for migrating one or more application between computing platforms comprising:
a migration module adapted to install application image blocks on a client computing platform according to a list; and
a communication module adapted to receive a list of application image blocks from a server.

12. The system according to claim 11, wherein said communication module is further adapted to receive application image blocks from a server.

13. The system according to claim 11, further comprising an application image block repository adapted to store application image blocks on a storage device associated with the client computing platform.

14. The system according to claim 13, wherein said communication module is further adapted to receive application image blocks from said application image block repository

15. Computer executable code stored on a digital storage medium and when executed by a processor of a computing platform said code adapted to cause the processor to:
scan mass storage devices associated with the computing platform and generate a list of identified application image blocks, and send the generated list to a server.

16. The code according to claim 15, further adapted to cause a processor to perform customized checks for specific components.

17. The code according to claim 15, further adapted to cause a processor to perform customized checks for user data.

18. Computer executable code stored on a digital storage medium and when executed by a processor of a computing platform said code adapted to cause the processor to:
download from a server a list of application image blocks and install the application image blocks on the computing platform.

19. The code according to claim 18, further adapted to cause a processor to download the application image blocks from a server.

20. The code according to claim 18, further adapted to cause a processor to download the application image blocks from a storage device.

21. A method for migrating one or more application between computing platforms comprising:
scanning a first client computing platform for identified application image blocks; generating a list of identified application image blocks; and
installing application image blocks on a second client computing platform according to the generated list.

22. The method according to claim 21, further comprising performing customized checks on the first computing platform for specific components.

23. The method according to claim 21, further comprising performing customized checks on the first computing platform for user data.

24. The method according to claim 23, further comprising saving information about specific components to be migrated.

25. The method according to claim 23, further comprising saving user data to a storage device.

26. The method according to claim 23, further comprising saving user data to a server.

27. The method according to claim 21, further comprising downloading application image blocks from a server.

28. The method according to claim 21, further comprising downloading application image blocks from an application image block repository on a storage device.

29. A system for migrating one or more application between computing platforms comprising:
a scanning module adapted to identify application image blocks on a first client computing platform;
a data storage device storing one or more sets of related software application image blocks, wherein a set of image blocks is associated with a software application and is generated by parsing components of the software application; and
a communication module adapted to exchange characterization data relating to image blocks with a client computer.
